(19) United States
(12) Patent Application Publication
(10) Pub. No.: US 2011/0141767 A1
(43) Pub. Date: Jun. 16, 2011

(54) UNIT FOR ILLUMINATING A LIGHT GUIDE PLATE FOR BACKLIGHTING A DIGITAL SCREEN PANEL

(75) Inventors: Benoît Box, Parmain (FR); Thierry Dommanget, Montalet le Bois (FR)

(73) Assignee: Johnson Controls Technology Company

(21) Appl. No.: 13/058,847

(22) PCT Filed: Aug. 5, 2009
(86) PCT No.: PCT/EP09/05667

§ 371 Date: Feb. 11, 2011

(30) Foreign Application Priority Data
Aug. 14, 2008 (DE) 10 2008 037 675.2
May 5, 2009 (FR) 09 02154

(51) Int. Cl. F21V 7/22

(52) U.S. Cl. 362/613

(57) ABSTRACT

The invention relates to a lighting unit (1) for illuminating at least one edge face of a light guide plate (9) designed to backlight a digital screen panel (11). The unit (1) has a printed circuit board (2) designed to be mounted behind the light guide plate (9), and at least one light-emitting member (3) electrically connected to the printed circuit board (2). The printed circuit board (2) has a main portion (4) designed to be mounted behind the light guide plate (9), and a secondary portion (6) extending the main portion (4) while also being angularly positioned in such a manner as to form an angle with said main portion (4) so as to be situated facing the edge face of the light guide plate (9), and the light-emitting members (3) are carried by the secondary portion (6). The invention is applicable to flat screens.

### CROSS REFERENCE TO RELATED APPLICATIONS

This application is a National Stage application of PCT/EP2009/005667, filed on Aug. 5, 2009, which claims priority of French Patent Application 09/02154, filed May 5, 2009 and German Patent Application No. 10 2008 037 675.2, filed Aug. 14, 2008. The foregoing applications are incorporated by reference herein in their entirety.

### FIELD

The invention relates to a solution for improving the compactness of a backlighting device for backlighting a digital screen panel.

### BACKGROUND OF THE INVENTION

A flat digital screen such as a screen of the Thin-Film Transistor (TFT) type or of some other type includes a digital panel on which the image to be viewed is displayed, and which is generally supplemented by a backlighting device that generates light passing through said panel to give the image the required brightness.

In practice, the panel has dots or picture elements (pixels) that are controlled individually by a graphics card to have given colors, and each dot or pixel passes light that is generated by a white light source situated behind the digital panel relative to a person looking at the screen.

In a known solution, the light source comprises a light guide plate that extends parallel to and behind the digital panel, together with one or more light-emitting members for lighting the edge face(s) of said light guide plate.

The light guide plate is designed to diffuse the light that it receives via its edge face(s) towards the digital panel and in sufficiently uniform manner for the screen to have substantially the same brightness at all of its pixels.

To this end, in addition to the digital panel and to the light guide plate, the screen includes a lighting unit comprising one or more light-emitting members and a printed circuit for powering and controlling said members.

Since high compactness is sought, the printed circuit of the lighting unit extends parallel to the light guide plate while being situated behind said light guide plate. The light-emitting members illuminating each edge thee of the light guide plate are carried by a flexible circuit of the flat cable type that is itself connected to the printed circuit via a connector.

In order to guarantee that the light-emitting members are positioned satisfactorily facing the edge face of the light guide plate, a distinct additional support is provided to which the flexible printed circuit is fastened, e.g. by adhesive bonding.

That architecture requires the flexible circuit to be positioned on the distinct support with sufficient accuracy to guarantee that the light-emitting members are situated facing the edge face to be lit, prior to fastening the circuit to the support.

Given the competitiveness that exists in such a field, the cost of that positioning operation is significant since it is detrimental to the overall cost of the finished item,

### OBJECT OF THE INVENTION

An object of the invention is to propose a solution for remedying that drawback.

### SUMMARY OF THE INVENTION

To this end, the invention provides a lighting unit for illuminating at least one edge face of a light guide plate designed to backlight a digital screen panel, which unit has a printed circuit board designed to be mounted behind the light guide plate, and at least one light-emitting member electrically connected to the printed circuit board, and designed to be situated facing an edge face of the light guide plate, wherein the printed circuit board has a main portion designed to be mounted behind the light guide plate, and at least one secondary portion extending the main portion while also being angularly positioned in such a manner as to form an angle with said main portion so as to be situated facing the edge face of the light guide plate, and wherein the light-emitting members are carried by the secondary portion.

With this solution, the printed circuit board and the light-emitting members form a rigid whole, so that the positioning and/or fastening of the printed circuit board, e.g. in and/or to a screen housing, is sufficient to ensure that the light-emitting members are positioned relative to the edge faces of the plate that they illuminate.

The invention also provides a unit as defined above, wherein the secondary portion extends perpendicularly to the main portion.

With this solution, the unit can equip a flat screen while reducing the overall amount of space needed around the digital panel and around the light guide plate.

The invention also provides a unit as defined above, wherein the printed circuit board is provided with a groove separating the main portion from the secondary portion, and in which the printed circuit board is folded at said groove.

The unit can thus be manufactured from a conventional printed circuit to which a scoring-and-folding operation is applied.

The invention also provides a unit as defined above, wherein the printed circuit board has electrical tracks that are situated on its face opposite from the face in which the groove is formed, and that interconnect the main portion and the secondary portion, and wherein each light-emitting member is electrically powered via said tracks.

The resulting printed circuit thus has both a physical support and also power supply means for the light-emitting members that can be mounted on the secondary portion like any normal electronic components.

The invention also provides a unit as defined above, wherein the printed circuit board has a main portion and a plurality of second portions inclined relative to the main portion.

The unit thus makes it possible, for example, to light a rectangular light guide plate via each of its edge faces, while making it necessary merely to position the single printed circuit relative to said light guide plate.

The invention also provides a display device including a digital screen incorporating a lighting unit as defined above.

The invention also provides a display device as defined above, wherein the printed circuit board is positioned and held via its main portion.

The invention also provides a display device as defined above, wherein the printed circuit board has a secondary portion forming an angle other than a right angle with the main portion.

The invention is applicable to various types of display device with which a motor vehicle can be equipped. It can be a display situated behind the steering wheel or in a central region of the dashboard or indeed it can be a display performing a rear view function, or indeed a display designed for enabling the rear occupants of the vehicle to view a television program.

By means of the freedom of choice of the angle between the main portion and the secondary portions, the geometrical shape of the lighting unit can be adapted simply to various different applications. In particular, navigation aid housings are generally of compact shape with the plane front face including the digital panel, and with the rear face being curved. In which case, an angle having a value different from a right angle can be particularly advantageous so that the main portion of the printed circuit board can extend along a portion of the back face.

### BRIEF DESCRIPTION OF THE FIGURES

FIG. 1 is a perspective view of the lighting unit of the invention;

FIG. 2 is a perspective view of a portion of the lighting unit of the invention situated at the junction between the main portion and the secondary portion of the printed circuit board;

FIG. 3 is a perspective view of the lighting unit of the invention associated with a light guide plate; and

FIG. 4 is a perspective view of the lighting unit of the invention associated with the light guide plate and with a digital panel.

### DETAILED DESCRIPTION OF THE INVENTION

The lighting unit of the invention that is referenced 1 in the figures includes a printed circuit board given overall reference 2 and carrying a series of sixteen light-emitting members, each of which is referenced 3, these members being light-emitting diodes (LEDs) in this example.

The printed circuit board 3 has a plane main portion 4 that has a generally rectangular outline defined by four edges referenced 4a to 4d. The edge 4a is extended by a secondary portion 6 that is in the general shape of a plane rectangular strip and that is inclined relative to said main portion 3.

The secondary portion 6 that extends perpendicularly to the main portion 4 carries the sixteen LEDs designed to light an edge face of a light guide plate. Said diodes are installed on the inside face of the secondary portion, i.e. on the face that is closer to the main portion, and they are aligned in a direction parallel to the main portion 4, while also being uniformly spaced apart from each other in such a manner as to generate lighting that is as uniform as possible.

The main portion 4 and the secondary portion 6 are defined relative to each other by a folding or “scoring-and-folding” operation whereby the printed circuit board is folded along a rectilinear groove 7 forming a score line.

The groove 7, one side of which corresponds to the edge 4a of the main portion, is obtained by a milling operation presenting precision sufficient to reduce the thickness of the component board of the printed circuit at said groove significantly, without reducing said thickness to zero.

Thus, at the groove 7, the printed circuit board 2 has a thickness e′ that is firstly sufficiently small to enable said board to be folded without any risk of it breaking, and secondly sufficiently large to ensure that the electrical tracks situated on the opposite face of said board are not interrupted or damaged by said folding operation.

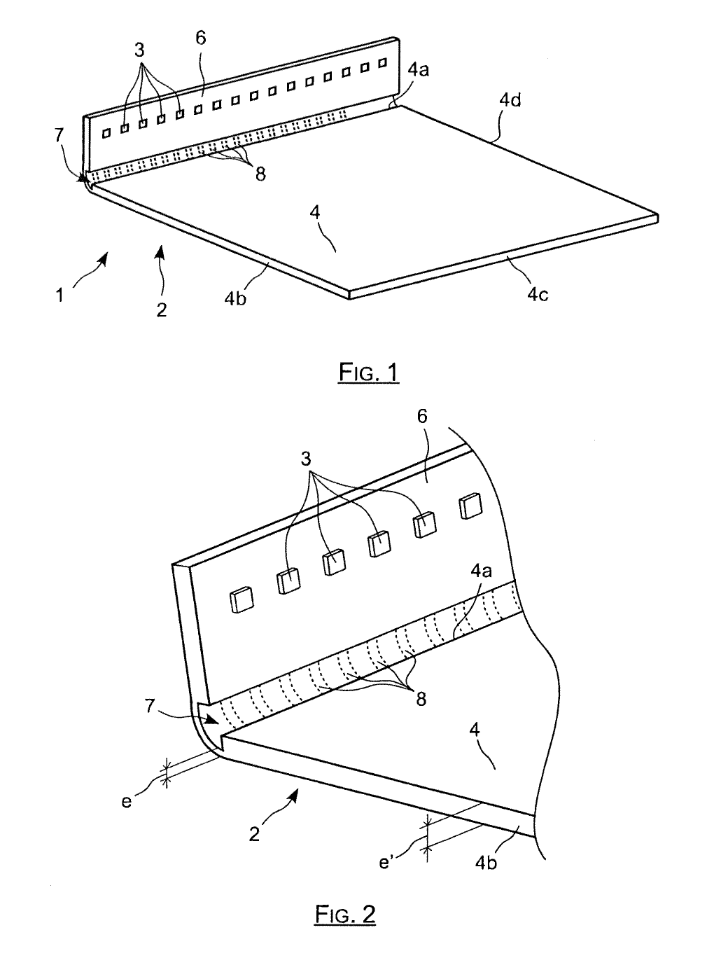

Said tracks that can be seen more clearly in FIG. 2 in which they are referenced 8 extend perpendicularly to the groove 7 so as to come to power and to control the various LEDs referenced 3.

As can be understood from the above, the light-emitting members that constitute the diodes 3 are carried by the secondary portion 4 while being fastened conventionally thereto like any electronic component. For example, each member that is installed on the inside face of said secondary portion has one or more pins engaged in corresponding holes in the secondary portion 6, each pin being soldered on the outside face of said secondary portion to a corresponding power and/or control electrical track 8.

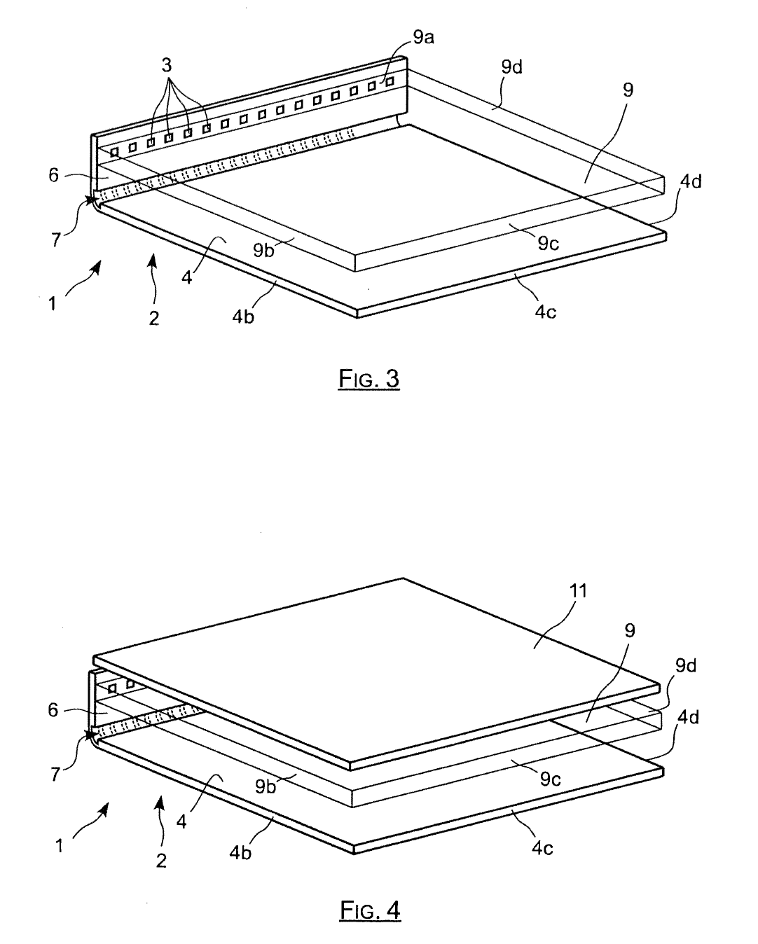

As shown diagrammatically in FIG. 3, the unit 1 is mounted in a housing (not shown) while being, for example, fastened to said housing, and while being positioned relative to a light guide plate 9 carried by said housing.

In this example, this plate 9 is of a plane shape that has a rectangular outline of the same dimensions as the main portion 4, having four face edges referenced 9a to 9d. As shown in FIG. 3, in the housing of this screen, the unit 1 is positioned relative to the plate 9 carried by this housing in such a manner that said main portion extends parallel to said plate 9, and such that the secondary portion 6 extends parallel to the edge face 9a of said plate while being situated facing said edge face, at a predetermined distance.

The main portion 4 of the printed circuit board 2 may be offset slightly backwards relative to the light guide plate. For example, said main portion carries electronic components for powering and controlling the light-emitting diodes.

Additionally, a digital panel shown in FIG. 4, in which it is referenced 11, is positioned in front of the light guide plate 9, while extending parallel thereto, so as to receive the light therefrom.

In the example shown in the figures, the printed circuit board 2 has a single secondary portion, but, as can be understood from the above, it is advantageously provided with four secondary portions, each of which extends one of its edges 4a to 4d, while also being perpendicular to the main portion 4. The unit then has the general shape of a rectangular block shaped cover in which the edges or secondary portions are dimensioned to surround the light guide plate in order to light each edge face.

It should be noted that the light-emitting members 3 that are carried by each secondary portion of the printed circuit board and that are constituted by LEDs in the figures may be replaced with other types of component. In particular, each series of diodes carried by a secondary portion may be replaced with a lamp of the neon type angularly positioned parallel to the main portion while also being carried by a secondary portion, and while being powered and controlled via the electrical tracks situated on the outside face of the printed circuit board.

What is claimed is:

1. A lighting unit for illuminating at least one edge face of a light guide plate designed to backlight a digital screen panel, the unit comprising:
a printed circuit hoard designed to be mounted behind the light guide plate; and
at least one light-emitting member electrically connected to the printed circuit board, and designed to be situated facing an edge face of the light guide plate,
wherein the printed circuit board has a main portion designed to be mounted behind the light guide plate, and at least one secondary portion extending the main portion while also being angularly positioned in such a manner as to form an angle with said main portion so as to be situated facing the edge face of the light guide plate, and wherein the light-emitting members are carried by the secondary portion.

2. A unit according to claim 1, wherein the secondary portion extends perpendicularly to the main portion.

3. A unit according to claim 2, wherein the printed circuit board is provided with a groove separating the main portion from the secondary portion, and in which the printed circuit board is folded at said groove.

4. A unit according to claim 3, wherein the printed circuit board has electrical tracks that are situated on its face opposite from the face in which the groove is formed, and that interconnect the main portion and the secondary portion, and wherein each light-emitting member is electrically powered via said tracks.

5. A unit according to claim 1, wherein the printed circuit hoard has a main portion and a plurality of second portions inclined relative to the main portion.

6. A display device, including a digital screen incorporating a lighting unit according to claim 1.

7. A display device according to claim 6, wherein the printed circuit board is positioned and held via its main portion.

8. A display device according to claim 6, wherein the printed circuit board has a secondary portion forming an angle other than a right angle with the main portion.
